(19) United States
(12) Patent Application Publication
(10) Pub. No.: US 2020/0200109 A1
(43) Pub. Date: Jun. 25, 2020

(54) SYSTEMS AND METHODS FOR PREVENTING THERMAL SPIKES AT EXHAUST GAS CATALYSTS

(71) Applicant: John D. Phillips, Brighton, MI (US)

(72) Inventor: John D. Phillips, Brighton, MI (US)

(21) Appl. No.: 16/225,735

(22) Filed: Dec. 19, 2018

(51) Int. Cl. F02D 41/02; F01N 3/10; F01N 3/20; F02D 41/14; F02D 41/12

(52) U.S. Cl. CPC F02D 41/0295; F01N 3/101; F01N 3/20; F02D 41/1441; F02D 2200/0816; F02D 41/1475; F02D 41/123; F02D 2200/0814; F02D 41/1454

(57) ABSTRACT

Systems and methods of preventing thermal spikes at a catalyst in an exhaust system of an engine of a vehicle include detecting whether one of a fuel enrichment event and a fuel cutoff event has been initiated and in response, temporarily disabling the other of the fuel enrichment event and the fuel cutoff event from occurring to prevent an exhaust gas temperature thermal spike that could damage the catalyst, while the other of the fuel enrichment event and the fuel cutoff event is disabled, performing stoichiometric closed-loop fuel control using the one or more oxygen sensors to drive the exhaust gas fuel/air ratio to stoichiometry and an oxygen storage capacity of the catalyst to a balanced state, and when measurements from the one or more oxygen sensors indicate at least one lean-to-rich transition and one rich-to-lean transition in the exhaust gas oxygen level has occurred, re-enabling the other event.

### FIELD

The present application generally relates to vehicle exhaust systems and, more particularly, to systems and methods for preventing thermal spikes at exhaust gas catalysts.

### BACKGROUND

Catalysts are typically implemented in vehicle exhaust systems for treating exhaust gas produced by an internal combustion engine to mitigate or eliminate emissions. A three-way catalytic converter (TWC) is a specific type of catalyst that is typically implemented in exhaust systems of vehicles having stoichiometric burn engines. The TWC operates by oxidizing carbon monoxide (CO) and unburnt hydrocarbons (HC) to produce carbon dioxide (CO2) and water (H2O), as well as reducing nitrogen oxides (NOx) to nitrogen (N2). When large quantities of either oxygen (O2) or HC accumulate on the TWC face, combustion often occurs when the other is introduced, which causes an exhaust gas temperature thermal spike. This thermal spike could degrade the TWC over time, and could also potentially cause permanent damage. Precious metals, such as platinum group metals (PGM), are often added to the TWC to extend its useful life in light of such exhaust gas temperature thermal spikes, but these metals are expensive. Accordingly, while these conventional exhaust systems do work well for their intended purpose, there remains a need for improvement in the relevant art.

### SUMMARY

According to one example aspect of the invention, a control system for an engine of a vehicle is presented. In one exemplary implementation, the control system comprises one of more oxygen (O2) sensors disposed proximate to a three-way catalytic converter (TWC) in an exhaust system of the vehicle, the one or more O2 sensors each being configured to measure an oxygen level of exhaust gas produced by the engine and a controller configured to: detect whether one of a fuel enrichment event and a fuel cutoff event has been initiated, wherein the fuel enrichment event comprises operating the engine with a rich fuel/air ratio and the fuel cutoff event comprises operating the engine with a lean fuel/air ratio, and in response to detecting that one of the fuel enrichment and the fuel cutoff event has been initiated: temporarily disable the other of the fuel enrichment event and the fuel cutoff event from occurring to prevent an exhaust gas temperature thermal spike that could damage the TWC, while the other of the fuel enrichment event and the fuel cutoff event is disabled, perform stoichiometric closed-loop fuel control using the one or more O2 sensors to drive the exhaust gas fuel/air ratio to stoichiometry and an oxygen storage capacity of the TWC to a balanced state, and when measurements from the one or more O2 sensors indicate at least one lean-to-rich transition and one rich-to-lean transition in the exhaust gas oxygen level has occurred, re-enable the other of the fuel enrichment event and the fuel cutoff event.

In some implementations, when the controller detects that the fuel enrichment event has been initiated, the controller temporarily disables the fuel cutoff event from occurring, performs the stoichiometric closed-loop fuel control, and then re-enables the fuel cutoff event when the measurements from the one or more O2 sensors indicate at least the lean-to-rich transition followed by the rich-to-lean transition in the exhaust gas oxygen level has occurred.

In some implementations, when the controller detects that the fuel cutoff event has been initiated, the controller temporarily disables the fuel enrichment event from occurring, performs the stoichiometric closed-loop fuel control, and then re-enables the fuel enrichment event when the measurements from the one or more O2 sensors indicate at least the rich-to-lean transition followed by the lean-to-rich transition in the exhaust gas oxygen level has occurred.

In some implementations, the controller is further configured to increment a counter each time a pair of lean-to-rich and rich-to-lean transitions in the exhaust gas oxygen level has occurred, and wherein controller is configured to re-enable the other of the fuel enrichment event and the fuel cutoff event when the counter exceeds a calibratable threshold that is greater than one.

In some implementations, the fuel enrichment event causes hydrocarbon (HC) to accumulate on a face of the TWC and the fuel cutoff event causes O2 to accumulate on the face of the TWC, and wherein the exhaust gas temperature thermal spike is caused by combustion of the accumulated HC or O2 on the face of the TWC when the other of HC and O2 is introduced into the exhaust gas.

In some implementations, the one or more O2 sensors comprise only a downstream O2 sensor relative to the TWC. In some implementations, the one or more O2 sensors comprise only an upstream O2 sensor relative to the TWC. In some implementations, the one or more O2 sensors comprise both an upstream O2 sensor and a downstream O2 sensor relative to the TWC. In some implementations, the one or more O2 sensors comprise one or more linear-type O2 sensors, one or more switching-type O2 sensors, or one or more of each of linear-type O2 sensors and switching-type O2 sensors. In some implementations, the engine is a stoichiometric engine that combusts gasoline, compressed natural gas (CNG), or liquefied natural gas (LNG).

According to another example aspect of the invention, a method of preventing thermal spikes at a TWC in an exhaust system of an engine of a vehicle is presented. In one exemplary implementation, the method comprises: receiving, by a controller and from each of one of more O2 sensors disposed proximate to the TWC in the exhaust system, a measured oxygen level of exhaust gas produced by the engine, detecting, by the controller, whether one of a fuel enrichment event and a fuel cutoff event has been initiated, wherein the fuel enrichment event comprises operating the engine with a rich fuel/air ratio and the fuel cutoff event comprises operating the engine with a lean fuel/air ratio, and in response to detecting that one of the fuel enrichment and the fuel cutoff event has been initiated: temporarily disabling, by the controller, the other of the fuel enrichment event and the fuel cutoff event from occurring to prevent an exhaust gas temperature thermal spike that could damage the TWC, while the other of the fuel enrichment event and the fuel cutoff event is disabled, performing, by the controller, stoichiometric closed-loop fuel control using the one or more O2 sensors to drive the exhaust gas fuel/air ratio to stoichiometry and an oxygen storage capacity of the TWC to a balanced state, and when measurements from the one or more O2 sensors indicate at least one lean-to-rich transition and one rich-to-lean transition in the exhaust gas oxygen level has occurred, re-enabling, by the controller, the other of the fuel enrichment event and the fuel cutoff event.

In some implementations, when the controller detects that the fuel enrichment event has been initiated, the controller temporarily disables the fuel cutoff event from occurring, performs the stoichiometric closed-loop fuel control, and then re-enables the fuel cutoff event when the measurements from the one or more O2 sensors indicate at least the lean-to-rich transition followed by the rich-to-lean transition in the exhaust gas oxygen level has occurred.

In some implementations, when the controller detects that the fuel cutoff event has been initiated, the controller temporarily disables the fuel enrichment event from occurring, performs the stoichiometric closed-loop fuel control, and then re-enables the fuel enrichment event when the measurements from the one or more O2 sensors indicate at least the rich-to-lean transition followed by the lean-to-rich transition in the exhaust gas oxygen level has occurred.

In some implementations, the method further comprises incrementing, by the controller, a counter each time a pair of lean-to-rich and rich-to-lean transitions in the exhaust gas oxygen level has occurred, and wherein controller is configured to re-enable the other of the fuel enrichment event and the fuel cutoff event when the counter exceeds a calibratable threshold that is greater than one.

In some implementations, the fuel enrichment event causes HC to accumulate on a face of the TWC and the fuel cutoff event causes O2 to accumulate on the face of the TWC, and wherein the exhaust gas temperature thermal spike is caused by combustion of the accumulated HC or O2 on the face of the TWC when the other of HC and O2 is introduced into the exhaust gas.

In some implementations, the one or more O2 sensors comprise only a downstream O2 sensor relative to the TWC. In some implementations, the one or more O2 sensors comprise only an upstream O2 sensor relative to the TWC. In some implementations, the one or more O2 sensors comprise both an upstream O2 sensor and a downstream O2 sensor relative to the TWC. In some implementations, the one or more O2 sensors comprise one or more linear-type O2 sensors, one or more switching-type O2 sensors, or one or more of each of linear-type O2 sensors and switching-type O2 sensors. In some implementations, the engine is a stoichiometric engine that combusts gasoline, CNG, or LNG.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a diagram of an example vehicle having a stoichiometric combustion engine and an exhaust system according to the principles of the present disclosure; and

FIG. 2 is a flow diagram of an example method of preventing thermal spikes at three-way catalytic converter (TWC) of the exhaust system of the vehicle according to the principles of the present disclosure.

### DETAILED DESCRIPTION

As previously mentioned, when large quantities of either oxygen (O2) or hydrocarbon (HC) accumulate on a face of a three-way catalytic converter (TWC), combustion often occurs when the other is introduced in the exhaust gas, which causes an exhaust gas temperature thermal spike that could degrade and/or permanently damage the TWC. Fuel enrichment events involve operating the engine with a rich fuel/air ratio, which results in HC unburnt fuel) accumulating at the face of the TWC. On the other hand, fuel cutoff or shutoff events, which typically occur during nearly closed throttle vehicle deceleration periods, involve operating the engine with a lean fuel/air ratio, which results in O2 accumulating at the face of the TWC. While fuel enrichment and fuel cutoff events do not occur simultaneously, there are times when these events occur immediately back-to-back or consecutively with minimal delay therebetween. For example only, a driver could tip-in an accelerator pedal, causing fuel enrichment, and then immediately tip-out the accelerator pedal, causing fuel cutoff, or vice-versa. Thus, there exists a need for improvement in the relevant art. Accordingly, systems and methods for preventing thermal spikes at exhaust gas catalysts are presented. The techniques employed by these systems and methods include preventing an exhaust gas temperature thermal spike caused by consecutive fuel enrichment and cutoff events or vice-versa.

By temporarily disabling the other of the fuel enrichment and cutoff events, these techniques provide the exhaust system time to clear any stored O2 or HC from the face of the TWC prior to the other event possibly being initiated. The presence of one of these events being initiated is known to a controller (e.g., a Boolean variable) and the fuel enrichment or cutoff event can be determined to have ended based on the detection of both rich-to-lean and a lean-to-rich transitions as monitored by one or more O2 sensors. This could include a downstream O2 sensor relative to the TWC, an upstream O2 sensor relative to the TWC, or both. For example only, when a fuel enrichment event is initiated, a lean-to-rich transition is expected and then a rich-to-lean transition is monitored for thereafter. Conversely, and for example only, when a fuel cutoff event is initiated, a rich-to-lean transition is expected and then a lean-to-rich transition is monitored for. Potential benefits of these techniques include smaller and/or less expensive TWCs (e.g., having less precious metals for improving or extending catalytic activity, such as platinum group metals, also known as PGM). It will be appreciated that a predetermined calibratable period could also be utilized instead of monitoring for these transitions, but this period would need to be sufficiently long for worst case scenarios and thus could be excessively long for other scenarios.

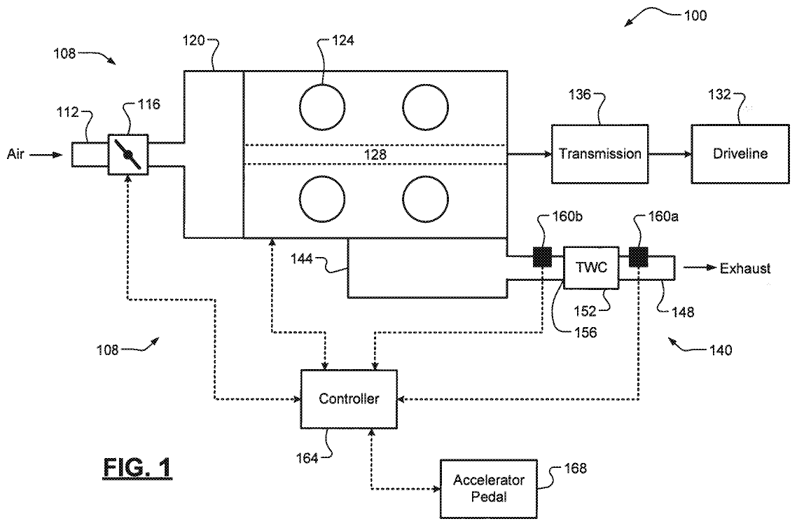

Referring now to FIG. 1, a diagram of an example vehicle 100 is illustrated. The vehicle 100 comprises a stoichiometric combustion engine 104. It will be appreciated that the engine 104 could also operate with a rich fuel/air ratio. Non-limiting examples of a type of fuel that the engine 104 could utilize include gasoline, compressed natural gas (CNG), and liquefied natural gas (LNG). Lean combustion engines, such as diesel engines, typically do not have a TWC because a stoichiometric or rich burn is required for NOx reduction. The engine 104 draws air through an induction system 108 comprising an induction passage 112, a throttle valve 116, and an intake manifold 120. The air in the intake manifold 120 is dispersed to cylinders 124 and combined with fuel to form a fuel/air mixture that is combusted (e.g., by spark plugs) within cylinders 124 to drive pistons (not shown) that rotatably turn a crankshaft 128 generating drive torque. While four cylinders are shown, it will be appreciated that the engine 104 could include any suitable number of cylinders (six, eight, etc.). The drive torque is transferred to a driveline 132 via a transmission 136. It will be appreciated that the vehicle 100 could have a hybrid driveline where the drive torque generated by the engine 104 is transferred to an electric motor or generator instead of or in addition to the transmission 136. Exhaust gas resulting from combustion is expelled from the cylinders 108 into an exhaust system 140. The exhaust system 140 comprises an exhaust manifold 144, an exhaust passage 148, and a TWC 152 disposed along the exhaust passage 148 and configured to mitigate or eliminate carbon monoxide (CO), HC, and nitrogen oxides (NOx) in the exhaust gas.

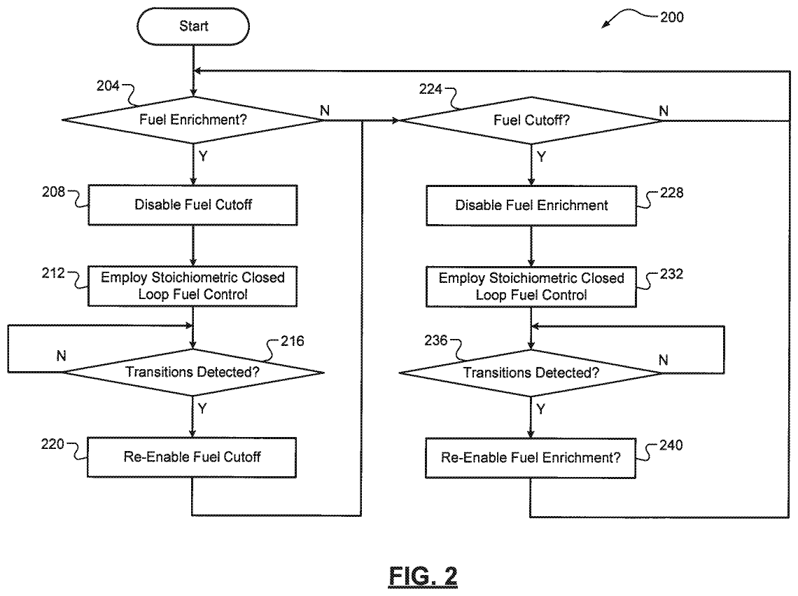

The TWC 152 defines a front face or surface 156 where exhaust gas components (HC, O2, etc.) accumulate before being involved in catalytic reactions. As previously discussed, the TWC 152 oxidizes the CO and HC (i.e., combines them with O2) to produce carbon dioxide (CO2) and water (H2O), and the TWC 152 reduces the NOx to nitrogen (N2) and O2. The exhaust system 140 further comprises one or more exhaust gas O2 sensors 160. While upstream and downstream O2 sensors 160b, 160a are illustrated relative to the TWC 152, it will be appreciated that the techniques of the present disclosure could be achieved using only one of these sensors 160a, 160b (e.g., to save costs). Using both of the sensors 160a, 160b, however, may increase the accuracy and/or robustness of the techniques. It will be appreciated that the O2 sensors 160a, 160b could be linear-type O2 sensors, switching-type O2 sensors, or some combination thereof. Whereas a switching-type O2 sensor switches its output in response to rich and lean fuel/air (FA) ratio transitions, a linear-type O2 sensor could output a voltage indicative of the FA ratio and thus this voltage could be monitored to determine when it passes through a voltage level associated with stoichiometry. A controller 164 controls operation of the engine 104, such as controlling airflow/fueling/spark to achieve a desired drive torque. This desired drive torque could be based, for example, on input provided by a driver of the vehicle 100 via an accelerator pedal 168. The controller 164 controls the engine 104 to perform fuel enrichment events (rich fuel/air ratio operation, such as for increased power or exhaust gas cooling) and fuel cutoff events (lean fuel/air ratio operation, such as no fuel being injected during pedal-off deceleration). The controller 164 also implements at least a portion of the techniques of the present disclosure, which are described in greater detail below with respect to FIG. 2.

Referring now to FIG. 2, a flow diagram of an example method 200 of preventing exhaust gas temperature thermal spikes is presented. At 204, the controller 164 determines whether fuel enrichment has been initiated. As previously mentioned, the controller 164 knows whether fuel enrichment is occurring (e.g., a Boolean variable of “0” or “1”). Fuel enrichment is performed, for example, for increasing engine power output or for cooling exhaust system catalysts. When true, the method 200 proceeds to 208. Otherwise, the method 200 proceeds to 220. At 208, the controller 164 temporarily disables fuel cutoff. This could include, for example, setting a Boolean variable for fuel cutoff disablement to “1” as opposed to “0.” At 212, the controller 164 performs stoichiometric closed-loop fuel control where the O2 sensors 160a, 160b are monitored to drive the exhaust gas fuel/air (FA) ratio to stoichiometry and the amount of O2 stored at the TWC 152, also known as its oxygen storage capacity (OSC) to a balanced state (e.g., approximately halfway between, or within a calibratable threshold from, its two extreme conditions of completely full and fully depleted). At 216, the controller 164 determines whether the requisite exhaust gas oxygen level transitions have occurred. This is intended to give the TWC 152 enough time for any accumulated HC to be removed from its face 156. This could include, for example, both one lean-to-rich transition (as expected) followed by one rich-to-lean transition occurring based on measurements from the one or more O2 sensors. It will be appreciated that the controller 164 could also monitor for multiple sets of transitions and increment a counter when each pair is detected. By using this counter and a calibratable threshold greater than one (two, three, four, etc.), the robustness of the technique could be increased (i.e., a greater certainty that the accumulated HC has been removed). When the transitions have been detected at 216, the method 200 proceeds to 220. Otherwise, the method 200 returns to 216.

At 220, the controller 164 enables fuel cutoff. This could include, for example, setting the Boolean variable for fuel cutoff disablement to “0” as opposed to “1.” At 224, the controller 164 determines whether fuel cutoff has been initiated. When true, the method 200 proceeds to 228. Otherwise, the method 200 returns to 204. At 228, the controller 164 temporarily disables fuel enrichment. This could include, for example, setting a Boolean variable for fuel enrichment disablement to “1” as opposed to “0.” At 232, the controller 164 performs stoichiometric closed-loop fuel control as described above with respect to 212. At 236, the controller 164 determines whether the requisite exhaust gas oxygen level transitions have occurred. Similar to 216, this is intended to give the TWC 152 enough time for any accumulated O2 to be removed from its face 156. This could include, for example, both one rich-to-lean transition (expected) followed by one lean-to-rich transition occur based on measurements from the one or more O2 sensors 160. Once both of these transitions occur, the period ends. Similar to 216, it will be appreciated that the controller 164 could also monitor for multiple sets of transitions and increment a counter when each pair is detected. By using this counter and a calibratable threshold greater than one (two, three, four, etc.), the robustness of the technique could be increased (i.e., a greater certainty that the accumulated O2 has been removed). When the transitions have been detected at 236, the method 200 proceeds to 240. Otherwise, the method 200 returns to 236. At 240, the controller 164 enables fuel enrichment. This could include, for example, setting the Boolean variable for fuel enrichment disablement to “0” as opposed to “1.” The method 200 then returns to 204.

It will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for an engine of a vehicle, the control system comprising:
one of more oxygen (O2) sensors disposed proximate to a three-way catalytic converter (TWC) in an exhaust system of the vehicle, the one or more O2 sensors each being configured to measure an oxygen level of exhaust gas produced by the engine; and
a controller configured to:
detect whether one of a fuel enrichment event and a fuel cutoff event has been initiated, wherein the fuel enrichment event comprises operating the engine with a rich fuel/air ratio and the fuel cutoff event comprises operating the engine with a lean fuel/air ratio; and
in response to detecting that one of the fuel enrichment and the fuel cutoff event has been initiated:
temporarily disable the other of the fuel enrichment event and the fuel cutoff event from occurring to prevent an exhaust gas temperature thermal spike that could damage the TWC,
while the other of the fuel enrichment event and the fuel cutoff event is disabled, perform stoichiometric closed-loop fuel control using the one or more O2 sensors to drive the exhaust gas fuel/air ratio to stoichiometry and an oxygen storage capacity of the TWC to a balanced state, and
when measurements from the one or more O2 sensors indicate at least one lean-to-rich transition and one rich-to-lean transition in the exhaust gas oxygen level has occurred, re-enable the other of the fuel enrichment event and the fuel cutoff event.

2. The control system of claim 1, wherein when the controller detects that the fuel enrichment event has been initiated, the controller temporarily disables the fuel cutoff event from occurring, performs the stoichiometric closed-loop fuel control, and then re-enables the fuel cutoff event when the measurements from the one or more O2 sensors indicate at least the lean-to-rich transition followed by the rich-to-lean transition in the exhaust gas oxygen level has occurred.

3. The control system of claim 1, wherein when the controller detects that the fuel cutoff event has been initiated, the controller temporarily disables the fuel enrichment event from occurring, performs the stoichiometric closed-loop fuel control, and then re-enables the fuel enrichment event when the measurements from the one or more O2 sensors indicate at least the rich-to-lean transition followed by the lean-to-rich transition in the exhaust gas oxygen level has occurred.

4. The control system of claim 1, wherein the controller is further configured to increment a counter each time a pair of lean-to-rich and rich-to-lean transitions in the exhaust gas oxygen level has occurred, and wherein controller is configured to re-enable the other of the fuel enrichment event and the fuel cutoff event when the counter exceeds a calibratable threshold that is greater than one.

5. The control system of claim 1, wherein the fuel enrichment event causes hydrocarbon (HC) to accumulate on a face of the TWC and the fuel cutoff event causes O2 to accumulate on the face of the TWC, and wherein the exhaust gas temperature thermal spike is caused by combustion of the accumulated HC or O2 on the face of the TWC when the other of HC and O2 is introduced into the exhaust gas.

6. The control system of claim 1, wherein the one or more O2 sensors comprise only a downstream O2 sensor relative to the TWC.

7. The control system of claim 1, wherein the one or more O2 sensors comprise only an upstream O2 sensor relative to the PNC.

8. The control system of claim 1, wherein the one or more O2 sensors comprise both an upstream O2 sensor and a downstream O2 sensor relative to the TWC.

9. The control system of claim 1, wherein the one or more O2 sensors comprise one or more linear-type O2 sensors, one or more switching-type O2 sensors, or one or more of each of linear-type O2 sensors and switching-type O2 sensors.

10. The control system of claim 1, wherein the engine is a stoichiometric engine that combusts gasoline, compressed natural gas (CNG), or liquefied natural gas (LNG).

11. A method of preventing thermal spikes at a three-way catalyst (TWC) in an exhaust system of an engine of a vehicle, the method comprising:
receiving, by a controller and from each of one of more oxygen (O2) sensors disposed proximate to the TWC in the exhaust system, a measured oxygen level of exhaust gas produced by the engine;
detecting, by the controller, whether one of a fuel enrichment event and a fuel cutoff event has been initiated, wherein the fuel enrichment event comprises operating the engine with a rich fuel/air ratio and the fuel cutoff event comprises operating the engine with a lean fuel/air ratio; and
in response to detecting that one of the fuel enrichment and the fuel cutoff event has been initiated:
temporarily disabling, by the controller, the other of the fuel enrichment event and the fuel cutoff event from occurring to prevent an exhaust gas temperature thermal spike that could damage the TWC,
while the other of the fuel enrichment event and the fuel cutoff event is disabled, performing, by the controller, stoichiometric closed-loop fuel control using the one or more O2 sensors to drive the exhaust gas fuel/air ratio to stoichiometry and an oxygen storage capacity of the TWC to a balanced state, and
when measurements from the one or more O2 sensors indicate at least one lean-to-rich transition and one rich-to-lean transition in the exhaust gas oxygen level has occurred, re-enabling, by the controller, the other of the fuel enrichment event and the fuel cutoff event.

12. The method of claim 11, wherein when the controller detects that the fuel enrichment event has been initiated, the controller temporarily disables the fuel cutoff event from occurring, performs the stoichiometric closed-loop fuel control, and then re-enables the fuel cutoff event when the measurements from the one or more O2 sensors indicate at least the lean-to-rich transition followed by the rich-to-lean transition in the exhaust gas oxygen level has occurred.

13. The method of claim 11, wherein when the controller detects that the fuel cutoff event has been initiated, the controller temporarily disables the fuel enrichment event from occurring, performs the stoichiometric closed-loop fuel control, and then re-enables the fuel enrichment event when the measurements from the one or more O2 sensors indicate at least the rich-to-lean transition followed by the lean-to-rich transition in the exhaust gas oxygen level has occurred.

14. The method of claim 11, further comprising incrementing, by the controller, a counter each time a pair of lean-to-rich and rich-to-lean transitions in the exhaust gas oxygen level has occurred, and wherein controller is configured to re-enable the other of the fuel enrichment event and the fuel cutoff event when the counter exceeds a calibratable threshold that is greater than one.

15. The method of claim 11, wherein the fuel enrichment event causes hydrocarbons (HC) to accumulate on a face of the TWC and the fuel cutoff event causes O2 to accumulate on the face of the TWC, and wherein the exhaust gas temperature thermal spike is caused by combustion of the accumulated HC or O2 on the face of the TWC when the other of HC and O2 is introduced into the exhaust gas.

16. The method of claim 11, wherein the one or more O2 sensors comprise only a downstream O2 sensor relative to the TWC.

17. The method of claim 11, wherein the one or more O2 sensors comprise only an upstream O2 sensor relative to the TWC.

18. The method of claim 11, wherein the one or more O2 sensors comprise both an upstream O2 sensor and a downstream O2 sensor relative to the TWC.

19. The method of claim 11, wherein the one or more O2 sensors comprise one or more linear-type O2 sensors, one or more switching-type O2 sensors, or one or more of each of linear-type O2 sensors and switching-type O2 sensors.

20. The method of claim 11, wherein the engine is a stoichiometric engine that combusts gasoline, compressed natural gas (CNG), or liquefied natural gas (LNG).
